(19) United States
(12) Patent Application Publication
(10) Pub. No.: US 2006/0087172 A1
(43) Pub. Date: Apr. 27, 2006

(54) Wheel cover assembly and method

(75) Inventor: Jerry A. Rayburn, Murray, KY (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignees: Jae Enterprises, Inc.; Jay Industries, Inc.

(21) Appl. No.: 10/970,125

(22) Filed: Oct. 21, 2004

(51) Int. Cl. B60B 7/00

(52) U.S. Cl. 301/37.105

(57) ABSTRACT

A wheel cover assembly and method are provided for covering an associated wheel rim and attaching to an associated wheel hub assembly. The hub assembly is of the type having a hub with lugs passing through lug openings on the associated wheel rim for threaded engagement with lug nuts for securing the wheel rim to the hub. The wheel cover assembly includes a wheel cover having a central opening through which the lugs of the associated hub assembly are received. A cap includes at least two circumferentially spaced apart openings positioned for alignment with at least two of the lugs. A retaining member is received through each of the spaced openings and is threadedly secured to one of the at least two lugs and lug nuts associated with the at least two lugs for retaining the cap and the wheel cover in mounted relation to associated hub assembly for at least partially covering the associated wheel rim.

### BACKGROUND

This invention relates to wheel covers and, more particularly, to decorative wheel covers mounted on a hub assembly of a vehicle for covering a wheel rim also mounted on the hub assembly. The invention is particularly applicable for use with hub assemblies and wheel rims of trucks, such as conventional pickup and/or commercial trucks, and will be described with particular reference thereto. It will be appreciated, however, that the invention is adapted to effective use in other environments and applications.

Wheel covers are generally known in the art with the majority of same being designed for use on passenger type vehicles or automobiles. However, with an ever increasing number of trucks, including conventional pickup trucks and commercial trucks, on the road, a demand has developed for wheel covers usable on such vehicles to enhance and improve the ornamental appearance of the wheels and the overall truck itself.

Heretofore, trucks and other larger vehicles were often provided with very plain wheel rims which many deem unattractive and lacking aesthetic appeal. For example, pickup trucks, particularly those with dual rear wheels, are often provided with dark steel wheel rims through which lugs pass and threadedly receive lug nuts for securely mounting the wheel rims to the wheel hubs. Center caps are sometimes disposed over a portion of these dark steel wheel rims to cover only the lugs and lug nuts. The center caps may be plated or painted to improve the aesthetics of the truck wheels, but they may still be considered unsightly since a portion of the wheel rims may remain exposed.

Accordingly, there has been a need in the industry for a wheel cover that is suitable for use with truck wheels and which will improve the overall aesthetics of a truck, particularly the wheels. Such a wheel cover would desirably be easy to manufacture and mount to a truck wheel assembly.

### SUMMARY

In accordance with a preferred embodiment, a wheel cover assembly is advantageously provided for an associated wheel rim and wheel hub assembly wherein the hub assembly includes a hub having lugs that pass through lug openings on the wheel rim for threaded engagement with lug nuts for securing the wheel rim to the hub. The wheel cover assembly includes a wheel cover having a central opening through which the lugs of the associated hub assembly are received. A cap includes at least two circumferentially spaced openings disposed for alignment with at least two of the lugs. A retaining member is received through each of the at least two circumferentially spaced openings and is engageable with one of (1) one lug of the at least two aligned lugs and (2) the lug nut thereon for securing the cap and the wheel cover to the associated hub assembly whereby the wheel cover and cap at least partially cover the associated wheel rim.

In accordance with another preferred embodiment, a wheel cover assembly is provided to include a cover having an opening defined therein adapted for receiving lug assemblies extending from a hub. A cap is received over the opening adapted for covering the lug assemblies. A plurality of retaining members are connectable to the lug assemblies for mounting the cover and the cap against an associated wheel rim so that the cover and cap are disposed in covering relation with the wheel rim. Engagement between the plurality of retaining members, cap and cover limits movement of the cover and the cap relative to the lug assemblies.

In accordance with yet another preferred embodiment, a method is provided for securing a wheel cover assembly over a wheel. According to the method, a wheel cover is provided having a central opening with projections and recesses extending radially into and out of the central opening, respectively. The wheel cover is positioned axially adjacent a wheel such that lugs with associated lug nuts extending outwardly from the wheel are passed through the central opening. A cap is placed axially adjacent the wheel cover over the central opening while passing the lugs with lug nuts toward cap openings defined in the cap. Retaining members are inserted through the cap openings and the wheel cover recesses, and are fixedly connected to at least one of the lugs and the lug nuts for securing the wheel cover and cap in covering relation to the wheel.

A principal advantage of the present invention resides in the provision of a wheel cover assembly that is easily mounted onto a conventional wheel rim.

Another advantage of the invention is found in the provision of a wheel cover assembly that mounts to at least one of lugs and lug nuts used in mounting a wheel rim.

Still another advantage of the invention is found in a wheel cover assembly that improves the aesthetic appearance of a wheel rim over which the wheel cover assembly is mounted.

Yet another advantage of the invention is the provision of a wheel cover assembly that can be mounted to and removed from an associated wheel rim without the need for removing the lug nuts themselves.

Still other advantages and benefits of the invention will become apparent to those skilled in the art and upon a reading and understanding of the following detailed description.

### BRIEF DESCRIPTION OF THE DRAWINGS

The invention may take physical form in certain parts and arrangements of parts, preferred embodiments of which will be described in detail in this specification and illustrated in the accompanying drawings which form a part hereof and wherein:

FIG. 1 is an exploded perspective view of a wheel cover assembly formed according to a first preferred embodiment of the invention for mounting over an associated wheel rim and onto an associated wheel hub assembly;

FIG. 2 is a front elevational view of a wheel cover of the wheel cover assembly of FIG. 1;

FIG. 3 is a side elevational view of the wheel cover of FIGS. 1 and 2;

FIG. 4 is a front elevational view of a cap of the wheel cover assembly of FIG. 1;

FIG. 5 is a side elevational view of the cap of FIGS. 1 and 4;

FIG. 6 is a side elevational view of a nut cap of the wheel cover assembly of FIG. 1;

FIG. 7 is a front elevational view of an alternate wheel cover formed according a second preferred embodiment of the present invention;

FIG. 8 is a side elevational view of the wheel cover of FIG. 7;

FIG. 9 is a front elevational view of an alternate cap for use with the wheel cover of FIG. 7; and,

FIG. 10 is a side elevational view of the cap of FIG. 9.

### DETAILED DESCRIPTION

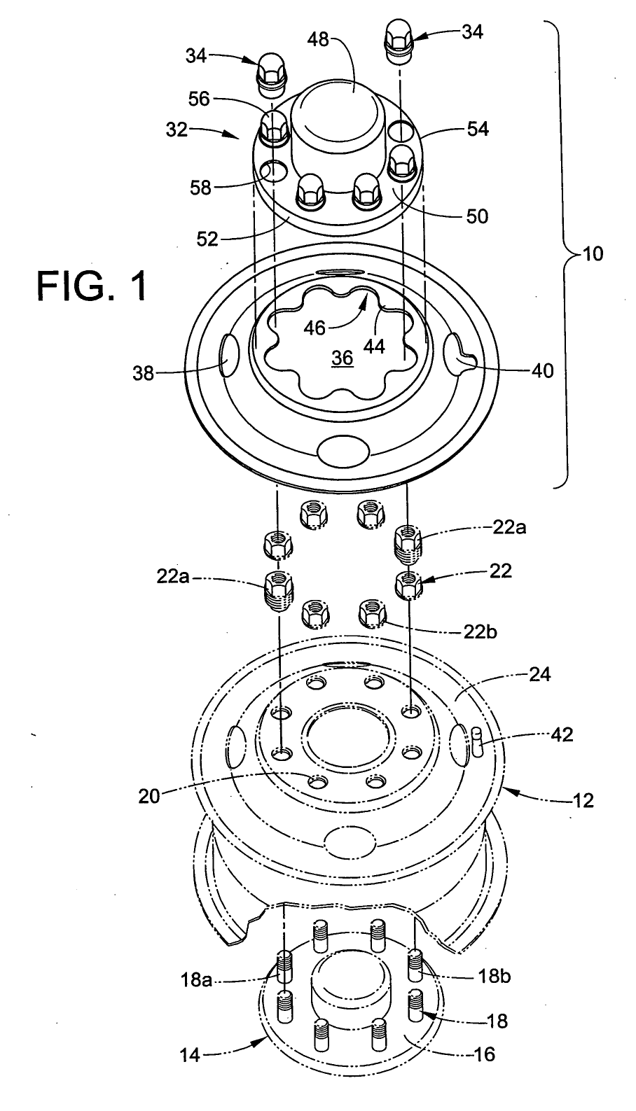

Referring now to the drawings wherein the showings are for purposes of illustrating preferred embodiments of the invention only and not for purposes of limiting the same, FIG. 1 shows a wheel cover assembly 10 for covering an associated wheel or wheel rim 12 and attaching to an associated wheel hub assembly 14. As is known, the hub assembly 14 generally includes a hub 16 having lugs 18 extending axially outward from the face thereof. The wheel 12, which carries a conventional inflatable tire (not shown), has lug openings 20 which receive the lugs 18 for purposes of mounting the wheel 12 to the hub 16.

More particularly, the wheel 12 is mounted to the hub 16 by aligning the lug openings 20 with the lugs 18 and moving the wheel toward the hub so that the lugs pass through the lug openings. To securely mount the wheel to the hub, lug nuts 22 are threadedly received on the lugs 18 and snugged against the wheel rim. Together, the lugs 18 and the lug nuts 22 form a lug assembly that retains the wheel on the hub. In the embodiment here under discussion, at least two of the lug nuts 22a are also externally threaded, and this feature is advantageously employed in a manner described hereinbelow. The remaining lug nuts 22b can be externally threadless, as shown, or alternatively can be the same as the externally threaded lug nuts 22a. Preferably, all of the lug nuts 22, including lug nuts 22b, are of the externally threaded variety like lug nuts 22a, but only lug nuts 22a are shown as being externally threaded in the illustrated embodiment for purposes of clarity in illustrating and describing how the wheel cover assembly 10 is seemed to the hub assembly 14. Often, a show surface 24 of the wheel 12 is plain and lacks an aesthetically pleasing appearance. For example, the show surface 24 may be a dark steel, plastic or other material, or may have a paint or other aesthetic coating applied thereon. To improve the appearance of the wheel, the wheel cover assembly 10 is mounted over the wheel and secured to the hub 16 as will be described.

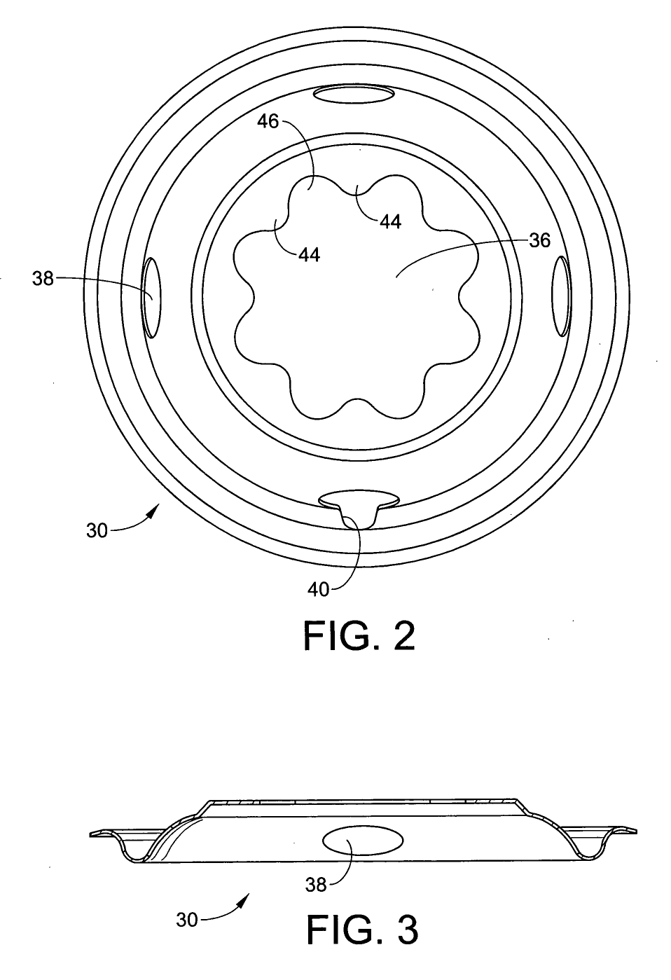

The wheel cover assembly 10 includes a wheel cover 30, a cap 32 and a plurality of retaining members 34 (two in the illustrated embodiment) for securing the wheel cover and the cap to the hub assembly 14. With additional reference to FIGS. 2 and 3, the wheel cover 30 defines a centrally disposed wheel cover opening 36 that receives the lugs 18 therethrough. The wheel cover 30 additionally defines a plurality of air openings 38 radially spaced from the opening 36 and circumferentially spaced relative to one another. In the illustrated embodiment, four (4) air openings 38 are shown. A recess 40 is disposed contiguous with one of the air openings 38 for receiving a valve stem 42 therethrough.

As shown, the wheel cover 30 includes a plurality of semi-circular areas or scallops 44 along the periphery of opening 36. Radially outward disposed recesses 46 are defined between adjacent scallops 44. At least two of the recesses 46 receive the retaining members 34. As will be described in more detail below, the retaining members are cooperable with the scallops 44 to prevent or limit any movement of the wheel cover 30 relative to the remainder of the overall assembly.

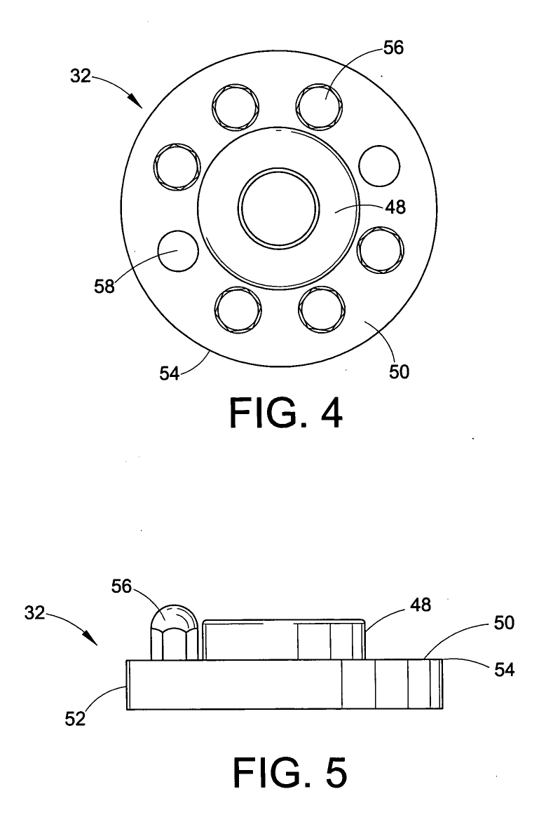

With additional reference to FIGS. 4 and 5, each cap 32 includes a central portion or protuberance 48 extending axially from a planarface or show surface 50 and a skirt 52 axially depending in the opposite direction from a circumferential edge 54 of the surface 50. The diameter of the skirt 52 is larger than the diameter of the wheel cover opening 36 in order that the cap 32 can cover the cover opening when secured to the hub 16. The skirt 52 is appropriately sized to fit over the lugs 18 of the hub assembly 14.

The cap 32 additionally includes a plurality of nut caps 56 disposed to extend axially from the show surface 50. In the illustrated embodiment, the nut caps 56 function to cover the terminal ends of the lugs 18 and add a decorative element to the overall cap 32. That is, the nut caps 56 give the appearance of being threaded onto the lugs 18 but, instead, are integrally formed with the cap 32. The caps 56 are circumferentially spaced on the show surface 50 and radially positioned between the protuberance 48 and the circumferential edge 54. Two circumferentially spaced openings 58 are defined in the show surface 50 and positioned so that each is located circumferentially between a respective three of the nut caps 56. As illustrated, the spaced openings 58 are preferably positioned substantially opposite one another, i.e., positioned on generally opposite sides of the protuberance 48, and positioned to be aligned with two of the lugs 18a, 18b upon which the externally threaded lug nuts 22a are threadedly received.

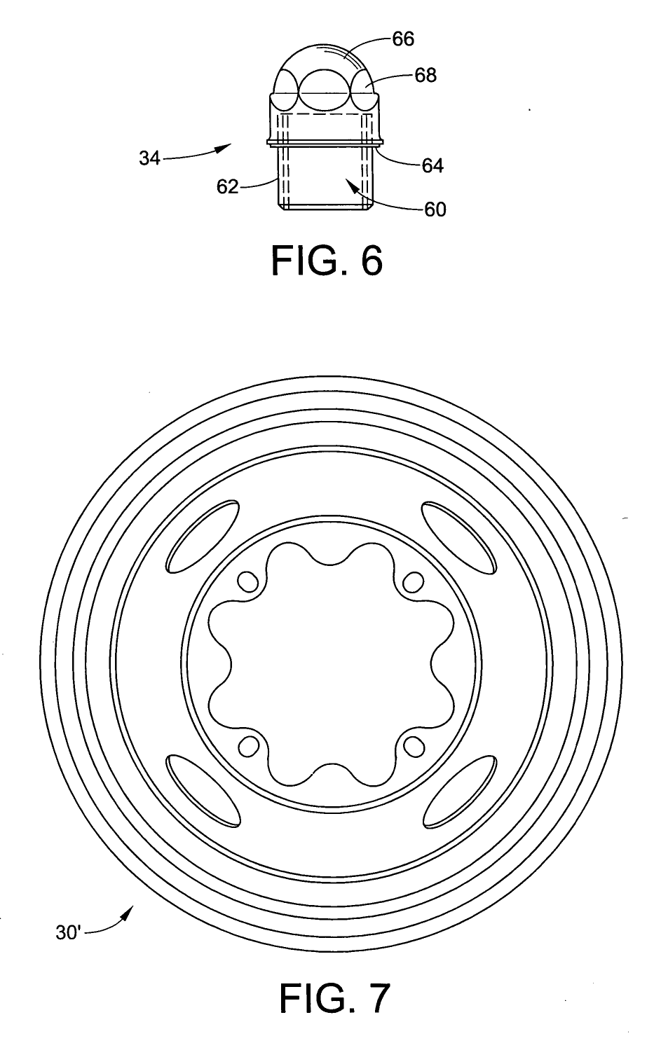

With further reference to FIG. 6, each of the retaining members 34 includes a skirt 60 having internal threads (not shown) for mating threaded engagement with the lug assemblies and, more specifically in the illustrated embodiment, with the externally threaded lug nuts 22a of the lug assemblies. The skirt 60 includes an outer surface 62 for mating or cooperative engagement with the scallops 44 of the wheel cover 30 to limit movement of the wheel cover relative to the hub assembly and the cap in a manner to be described. Each of the retaining members 34 further includes a rounded portion 64 adjacent the skirt 60. The rounded portion 64 has a larger diameter than the outer surface 62 thereby defining a shoulder 66 between the rounded portion and the skirt. In an assembled state, the shoulder 66 rests against the show surface 50 of the cap 31. Engaging surfaces or flats 68 are provided circumferentially about the rounded portion 64 to facilitate ease of turning the retaining members.

In a preferred embodiment, one or more of the wheel cover 30, the cap 32 and the retaining members 34 may be decoratively coated, painted or polished as may be desired. These components cover at least a portion of the wheel 12 and function to provide an aesthetically pleasing appearance, particularly where the show surface 24 of the wheel 12 lacks such an appearance. When assembled and mounted, the cover 30 and cap 32 together appear as a unitary structure rather than two separate components, and often appear as the wheel rim 12 itself. The wheel cover 30 and/or the cap 32 can be formed or molded from a variety of different metallic and non-metallic materials as may be desired to achieve the intended results.

The wheel cover assembly 10 further includes a means for limiting movement of the wheel cover 30 relative to the hub assembly 14 when the wheel cover and cap 32 are mounted thereto. In the illustrated embodiment, the limiting means includes cooperative engagement between the retaining members 34 and scallops 44. More specifically, when the retaining members 34 are received within the recesses 46 defined between adjacent scallops 44, the mating surface 64 of the retaining members engages adjacent scallops. Since the retaining members are threadedly engaged to the lug nuts 22a and thereby fixed relative to the hub assembly, the scallops 44 effectively lock the position of the wheel cover 30 relative to the hub assembly 14 by their cooperative engagement with the retaining members.

To secure the wheel cover assembly 10 to the hub assembly 14 and over the wheel 12, the wheel cover is positioned on or against the wheel with the lugs 18 and associated lug nuts 22 received through the opening 36. Specifically, the lugs with nuts are received through recesses 46 defined between contiguous scallops 44. Valve stem 42 is conveniently received through the recess 40. The cap 32 is positioned on the wheel cover 30 to enclose the opening 36, and two of the lug assemblies and, more specifically, two of the lugs 18a,18b with associated nuts 22a are received at least closely adjacent to openings 58 defined in the cap. The retaining members 34 are then received through the openings 58 and threadedly advanced onto the lug assemblies and, more specifically, the lug nuts 22a for securing the cover 30 and cap 32 to the wheel 12 and hub assembly 14.

In the mounted state, the retaining member shoulder 66 rests against the surface 50 of the cap 32. The engaging surfaces 68 can be used to facilitate tightening of the retaining members 34 onto the lug nuts 22a′. With the retaining members threadedly secured to the lug nuts, the wheel cover assembly is axially secured to hub assembly 14. The engagement between the retaining members 34 and the scallops 44 prevents rotational and transverse movement of the wheel cover. The engagement between the retaining members 34 and the openings 58 of the cap 32 prevents rotational and transverse movement of the cap relative to the hub assembly.

As previously noted, when the wheel cover assembly 10 is secured to the hub assembly 14 over the wheel 12, the wheel cover assembly at least partially covers the wheel. In the illustrated embodiment, the wheel cover assembly substantially covers the wheel 12 and, accordingly, is viewed in place of the wheel 12 by onlookers. The construction of the cover and cap is such that they themselves appear as the wheel rim. One highly desirable feature of the subject development resides in the fact that the wheel cover assembly may be installed and removed from association with the wheel assembly without disturbing any of lug nuts 22 from their wheel assembly retaining positions.

Although the illustrated embodiment employs scallops projecting from the wheel for engagement with the retaining members, it is to be appreciated by those skilled in the art that other configurations are feasible and should be considered well within the scope of the present invention. For example, the scallops provided around each retaining member could be replaced with inwardly projecting members or prongs of any of a variety of shapes. Another alternative example includes utilizing retaining caps that threadedly engage lugs obviating the need for externally threaded lug nuts. Moreover, it should be appreciated that more than two retaining members could be used simply by replacing a corresponding number of nut caps 56 with openings similar to openings 58 and providing additional externally threaded lug nuts. Further, the number of scallops could be altered to correspond exactly with the number of retaining members 34. Still further, the threaded engagement between the retaining members and the lug nuts could be replaced with any other suitable connection, including press fitting, gripping fingers, and other suitable mechanical retention devices. These would be particularly beneficial in cases where lug nuts 22 are not externally threaded in the manner hereinabove described.

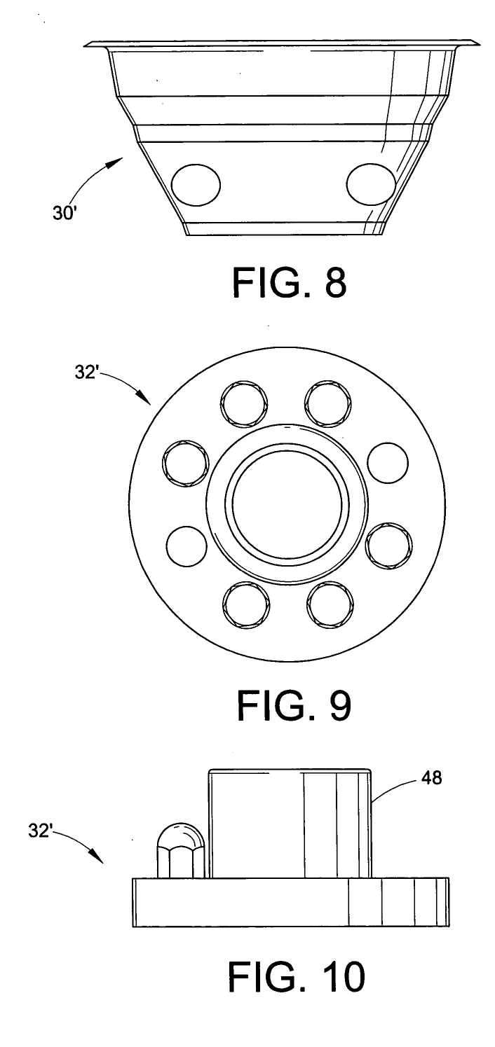

With reference to FIGS. 7-10, and according to another embodiment, a second wheel cover assembly is shown for covering an associated wheel and attaching to an associated hub assembly to which the wheel is mounted. There, like components are identified by like numerals with a primed (′) suffix for ease of appreciating this alternative arrangement. The second wheel cover assembly includes a wheel cover 30′, a cap 32′ and uses retaining members similar to members 34 as previously described. The wheel cover 30′ has a deep conformation, as compared to the relatively shallow conformation of the wheel cover 30. The deeper conformation enables this second wheel cover assembly to be used with vehicle wheels having or requiring a similar or matching conformation. In most other respects, the cover 30′ is the same as the cover 30 as previously described.

The cap 32′ includes a more pronounced protuberance 48′ to better match the deep conformation of the wheel cover 30′. However, in most other respects, the cap 32′ is the same as the cap 32. The second wheel cover assembly is secured to a hub assembly for covering a wheel in the manner described above with reference to the wheel cover assembly 10.

The invention has been described with reference to preferred embodiments. Obviously, modifications and alterations will occur to others upon a reading and understanding the preceding detailed description. It is intended that the invention be construed as including all such modifications and alterations insofar as they are within the scope of the appended claims or the equivalents thereof.

1. A wheel cover assembly for an associated wheel rim and wheel hub assembly wherein said hub assembly includes a hub having lugs that pass through lug openings on said wheel rim for threaded engagement with lug nuts for securing said wheel rim to said hub, said wheel cover assembly comprising:
a wheel cover having a central opening through which the lugs of said associated hub assembly are received;
a cap including at least two circumferentially spaced openings disposed for alignment with at least two of said lugs; and,
a retaining member received through each of said at least two spaced openings and retainingly engageable with one of said at least two lugs and lug nuts associated with said at least two lugs for securing said cap and wheel cover to the associated hub assembly whereby said wheel cover and cap at least partially cover the associated wheel rim.

2. The wheel cover assembly of claim 1 further including a means for limiting movement of said wheel cover relative to said hub assembly.

3. The wheel cover assembly of claim 2 wherein said limiting means includes:
scallops disposed along at least a portion of said wheel cover central opening; and,
a mating surface included on said retaining member for cooperating engagement with said scallops.

4. The wheel cover assembly of claim 2 wherein said limiting means comprises at least one of said cap and said retaining members disposed in engagement with said wheel cover.

5. The wheel cover assembly of claim 2 wherein said limiting means includes:
portions of said wheel cover extending radially inward into said central opening and adapted for engaging at least one of said cap, lugs, lug nuts and retaining members.

6. The wheel cover assembly of claim 1 wherein said cover includes scallops defining said central opening, said scallops adapted to cooperate with at least one of said lugs, lug nuts and retaining members for limiting radial and transverse movement of said wheel cover relative to the associated hub assembly.

7. The wheel cover assembly of claim 1 wherein said cover includes a plurality of generally curved projections extending radially inward of said central opening cooperable with said retaining member for limiting radial and transverse movement of said wheel cover relative to the associated hub assembly.

8. The wheel cover assembly of claim 1 wherein said cap includes integrally formed decorative nut caps, said decorative nut caps and said spaced openings of said cap being circumferentially spaced and positioned to be aligned with the lugs of the associated hub assembly.

9. The wheel cover assembly of claim 1 further including an axially depending skirt appropriately sized to fit over the lugs of the associated hub assembly.

10. The wheel cover assembly of claim 1 wherein the lug nuts associated with said at least two lugs are externally threaded and said retaining members include internal threads adapted for threaded mounting thereto.

11. The wheel cover assembly of claim 10 wherein said retaining members include a skirt having said internal threads and an outer surface cooperable with said wheel cover for limiting movement of said wheel cover relative to the associated hub assembly and said cap.

12. The wheel cover assembly of claim 1 wherein said cover includes a plurality of circumferentially spaced openings radially spaced from said central opening.

13. The wheel cover assembly of claim 12 wherein one of said plurality of circumferentially spaced openings includes a recess for receiving a valve stem extending from the hub of the associated hub assembly.

14. The wheel cover assembly of claim 1 wherein said cover is one of a shallow cup-like conformation and a deep cup-like conformation.

15. A wheel cover assembly comprising:
a cover having an opening defined therein adapted for receiving lug assemblies extending from a hub;
a cap received over said opening adapted for covering the lug assemblies;
a plurality of retaining members securable to the lug assemblies for mounting said cover and said cap against an associated wheel rim so that said cover and cap are disposed in covering relation with the wheel rim; and,
wherein engagement between said plurality of retaining members, cap and cover limits movement of said cover and said cap relative to the lug assemblies.

16. The wheel cover assembly of claim 15 wherein said cap includes at least two apertures which are alignable with two of the lug assemblies and wherein said plurality of retaining members are received in said at least two apertures.

17. The wheel cover assembly of claim 15 wherein said cover includes scallops along an edge defining said opening and wherein said scallops and retaining members are in engagement for limiting movement of said cover relative to the associated wheel rim.

18. The wheel cover assembly of claim 15 wherein said retaining members are internally threaded and adapted for threaded engagement with external threads on associated lug nuts of the lug assemblies.

19. A method for securing a wheel cover assembly over a wheel, comprising the steps of:
providing a wheel cover having a central opening with projections and recesses extending radially into and out of said central opening, respectively;
positioning said wheel cover axially adjacent a wheel such that lugs and associated lug nuts extending outwardly from the wheel are passed through said central opening;
placing a cap axially adjacent said wheel cover over said central opening while passing the lugs and associated lug nuts toward cap openings defined in said cap;
inserting retaining members through said cap openings and said wheel cover recesses; and,
fixedly connecting said retaining members to at least one of the lugs and the associated lug nuts for securing said wheel cover and cap in covering relation to the wheel.

20. The method of claim 19 wherein said step of connection comprises threadedly advancing said retaining members on the associated lug nuts.
